(19) United States
(12) Patent Application Publication
(10) Pub. No.: US 2007/0083527 A1
(43) Pub. Date: Apr. 12, 2007

(54) Systems and methods for uploading and downloading files in a distributed network

(76) Inventors: David Wadler, New York, NY (US); David R. Wegman, San Francisco, CA (US); Bruce Wang, San Pablo, CA (US)

Correspondence Address: RICHARD F. JAWORSKI;Cooper & Dunham LLP, 1185 Avenue of the Americas, New York, NY, 10036, US

(21) Appl. No.: 11/544,885

(22) Filed: Oct. 6, 2006

Related U.S. Application Data
(60) Provisional application No. 60/724,516, filed on Oct. 7, 2005.

(51) Int. Cl. G06F 17/30

(52) U.S. Cl. 707/10

(57) ABSTRACT

A method for processing video includes providing a framegrabbing plugin that extracts still frames from a video stream and is integrated into an application that hosts plugins and providing a user interface allowing a user to select still frames to extract from the video.

### REFERENCE TO RELATED APPLICATION

This application is based on and claims the benefit of Provisional application Ser. No. 60/724,516, filed Oct. 7, 2005, the entire contents of which are herein incorporated by reference.

### BACKGROUND OF THE DISCLOSURE

1. Field of the Disclosure

The present disclosure relates to uploading and downloading files and, in particular, to systems and methods for uploading and downloading files in a distributed network.

2. Description of the Related Art

Framegrabbing. There are a variety of video-editing as well as standalone applications that can be used to extract one or more frames from a digital video file. Typically, such applications are necessary as the video acceleration techniques employed by modern hardware and operating systems prevent users from taking simple “screenshots” of video files. For example, if an individual has a video and uses a standard media player application to locate a particular frame and attempts a screen capture, the resulting image will often be a black rectangle instead of the desired frame. By using a frame grabber, a user can generate one or more still images from a video. While many such applications exist that support such functionality, users are generally required to download, install, and configure them. In addition, there are often complex user interfaces to learn in order to complete the frame grabbing process.

Transcoding video. There exist many transcoding applications that are available to users who choose to manipulate audio or video files. There are many variables that can be configured when converting files. The present disclosure concerns itself with several of these variables, including two of the more significant variables: codec and container. The codec deals with the method of compression and decompression used on the audio/video. The container implements a particular specification for the file format. Using a transcoder, video implementing a particular codec and container can be “transcoded” so the resulting file uses a specified codec and container.

Transcoders have traditionally been used via a command-line interface and have required fairly complex tweaking of parameters. More recently, developers have created transcoding applications with graphical user interfaces. These have simplified the transcoding process to a large degree, but the task remains highly technical and laden with complex jargon.

File uploads. Prior to web interfaces, users would typically download, install, and run file transfer protocol (FTP) client applications to upload their files. Web-based uploads using HTTP are simpler for users to understand, and are how mail services like Yahoo Mail and Hotmail handle email attachments. There are a variety of other web sites, one example being those to which users post photos, which allow users to upload content using the same HTTP upload functionality.

User quotas. Limiting users by file size and/or total storage is a common practice among many applications. However, when the files in question are media files, such as audio or video, the running time of the file is sometimes not considered. Since media files vary widely in file size due to a variety of reasons, basing the limitation on the length in time would be a more desirable way of limiting user uploads.

Content delivery networks. A distributed content network is a network in which content is inserted into the network such that any client that is part of the network can share any of its hosted content with his peers and any client can add new content to the network. This type of distributed network is most commonly known as a Peer-to-Peer (P2P) network. Systems may use a unique identifier for identifying content which is based on the bytes of a particular file, called a hash. These systems may be referred to in the present disclosure as the Content Identifier Component or CIC. Verification of a particular piece of content is also used by some systems. These systems may be referred to in the present disclosure as the Content Verification Component or CVC.

Many systems employ methods to ensure that content within the network is permitted to be there, and the use of a hash and a central server such as the CVC are sometimes used to performing this task. However, traditional content networks that employ validation methods are often closed and not distributed. In most cases, these systems are administered on a central server that manages a set of content servers owned by the network. Clients do not download content from each other, therefore preventing P2P relationships. Furthermore, clients are usually not allowed to upload content to the network's content servers. On the other hand, P2P networks often have the ability to share content between their peers, allow for any content to be shared and use the concept of hashes to identify the content. However, the use of a central management server that can accept and deny content based on some predetermined criteria, and that can then compel clients to accept or-reject the content is not employed. Furthermore, such a concept is, in most cases, not practical or possible with a typical P2P network. Finally, because P2P networks are not managed, the peers in the networks act autonomously. Each client has a list of content files, and decides on its own whether it will make a file available to other clients in the network. Furthermore, a user initiates the process of downloading a new file. Embodiments of the present disclosure combine the concepts employed by content networks and apply them to an open distributed network.

### SUMMARY

A method for processing video comprises providing a framegrabbing plugin that extracts still frames from a video stream and is integrated into an application that hosts plugins and providing a user interface allowing a user to select still frames to extract from the video.

A method for converting a media file comprises a file information extractor plugin that extracts information from a file and is integrated into an application that hosts plugins and a transcoder for converting a media file as a result of a user's interaction with the application that hosts plugins.

A software plugin comprises code for extracting information from a file and code for comparing the extracted information to at least one list to determine whether transcoding of the file is at least one of required and possible.

A method for validating content comprises determining whether content should be accessible to peers on a P2P network and allowing a user to mark his own content uploaded to a P2P network as invalid.

A distributed computer network comprises a central administrative server and at least one client including at least one content file, wherein the central administrative server sends said at least one client instructions describing which of the at least one content files should be made available to other clients.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows the relationship of various embodiments of the present disclosure to a web browser, operating system, and hardware of a client computer.

FIG. 2 is an explanation of the flow-of-control in the application itself according to an embodiment of the present disclosure.

FIGS. 3A-3C are used to describe what the user experience is like using the web-based frame grabber according to an embodiment of the present disclosure.

FIG. 4 shows how the key components interact with one another in the flow-of-control according to an embodiment of the present disclosure.

FIG. 5 demonstrates the programmatic flow-of-control during a web-based transcode operation according to an embodiment of the present disclosure.

FIG. 6 describes the process by which a user uploads content according to an embodiment of the present disclosure.

FIG. 7 shows the interaction between all of the components during a web-driven client upload according to an embodiment of the present disclosure.

FIG. 8 explains the sequence of steps the disclosure goes through to handle a time-based quota system according to an embodiment of the present disclosure.

FIG. 9 displays a sample screenshot related to a time-based quota implementation specific to video media files according to an embodiment of the present disclosure.

FIG. 10A-10B describes how the disclosure performs content validation in four different scenarios according to various embodiments of the present disclosure. The components include:

Content Identification Component (CIC). Creates unique identifier for any piece of content, plus a signature, which can be used to determine if two pieces of content are similar

Content Verification Component (CVC). Manages a list of content identifiers created by the CIC, including ways to programmatically add and remove from this list. Processes requests to verify any content identifier against its managed list

Client Content Management Component (CMC). Uploads content using the CIC and interacting with the CVC. Checks content that it downloads against the CVC, removing invalid content and downloading valid content

FIG. 11 explains the relationship between components in a grid-based CDN for the purpose of controlling content availability according to an embodiment of the present disclosure.

The Server maintains a list of files in the network.

One or more Semi-Autonomous Clients (SACs) query a Server for instructions. The set of instructions indicates what content to make available or unavailable.

As with SACs, one or more DCs can query a Server for instructions. However, unlike SACs, DCs can also be sent instructions by a Server.

FIG. 12 explains the sequence of steps, “Centralized control of each dedicated client's (DC) file allocation,” according to an embodiment of the present disclosure.

FIG. 13 explains the sequence of steps, “Clients query for instructions regarding desired availability,” according to an embodiment of the present disclosure.

FIG. 14 explains the sequence of steps, “Clients use rules to determine desired availability,” according to an embodiment of the present disclosure.

### DETAILED DESCRIPTION OF THE DISCLOSURE

In the following detailed description of the preferred embodiments, reference is made to the accompanying drawings, which form a part hereof, and within which are shown by way of illustration specific embodiments by which the disclosure may be practiced. It is to be understood that other embodiments may be utilized and structural changes may be made without departing from the scope of the present disclosure.

### Web-Based Frame Grabbing

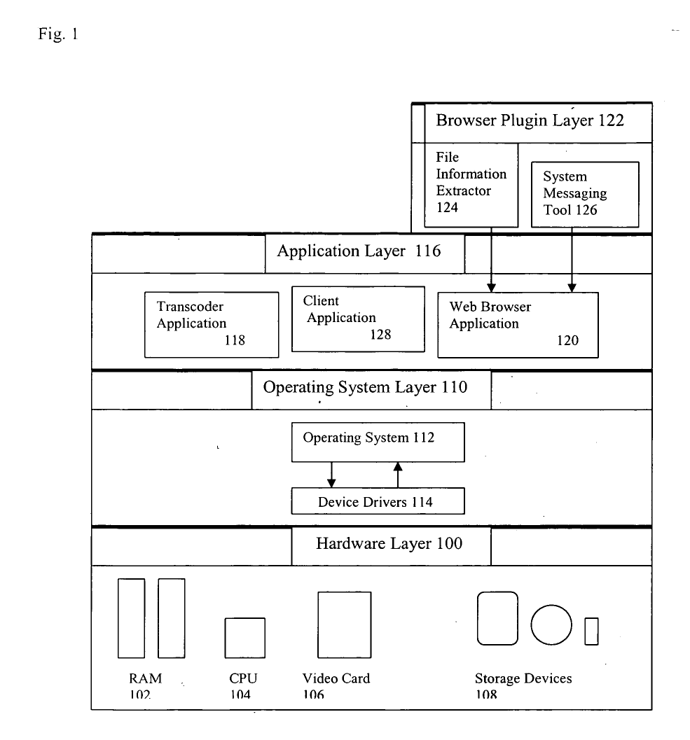

According to embodiments of the present disclosure, a software tool allows a user to extract a single-frame to an image file from a digital video file. Applications that are used for frame grabbing are often multi-purpose. These applications can be difficult to use if the primary goal is to extract a single frame of video and store it on disk. FIG. 1 shows a portion of the present disclosure as it relates to a hierarchical model of a computer. As shown, hardware layer 100 may include RAM 102, CPU 104, video card 106 and storage devices 108. Of course, the hardware layer may include various other items. Operating system layer 110 includes an operating system 112 and device drivers 114. Application layer 116 may include a transcoder application 118 to be described later and web browser application 120. A browser plugin layer 122 may include a file information extractor 124 and a system messaging tool 126. Stand-alone applications that support frame grabbing often exist in the application layer, adjacent to the web browser. However, according to embodiments of the present disclosure, a web browser based frame grabber functions as a web browser “plugin.” In one such web browser, Internet Explorer, the plugin can be written as an ActiveX control. Embodiments of the present disclosure are executed inside a web-browser 120 or some other application that supports the same scripting features as a web browser.

When the web-based frame grabber has been loaded into a web browser 120, it can be controlled with scripting. Possible web scripting languages that work in concert with the disclosure include, but are not limited-to, Javascript, JScript, and VBScript. To integrate frame grabbing into a web page, the disclosure can be compiled into a dynamically loadable construct. As an example, two such constructs that exist on the Windows operating system are the dynamic linked library (DLL) and the OLE custom control (OCX) files. According to yet another embodiment of the present disclosure, a web browser can be compiled with frame grabbing support statically linked to it. A web page hosting the control, which could be a static page or dynamically generated, can reference the compiled code constituting the disclosure, by using an object or embed tag, or another tag or method. Then, using a scripting language that is supported by the browser, the present system can be instructed to extract a frame and write it to disk as an image file.

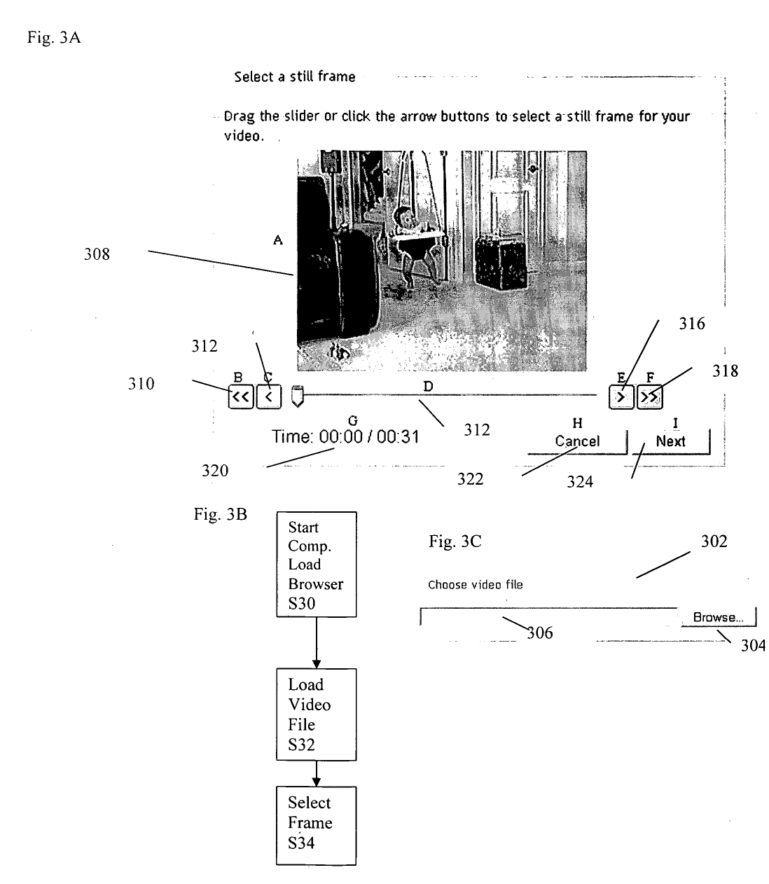

An embodiment of a user interface that can be presented to the user is shown in FIG. 3B. In this embodiment of the present disclosure, one or more user interface elements, such as frame-stepping buttons (310, 312, 316 and 318) and a slider 314 (see screenshot in FIG. 3, Step 3), can be added to the frame grabber, thereby allowing the user a way to choose the frame that should be extracted.

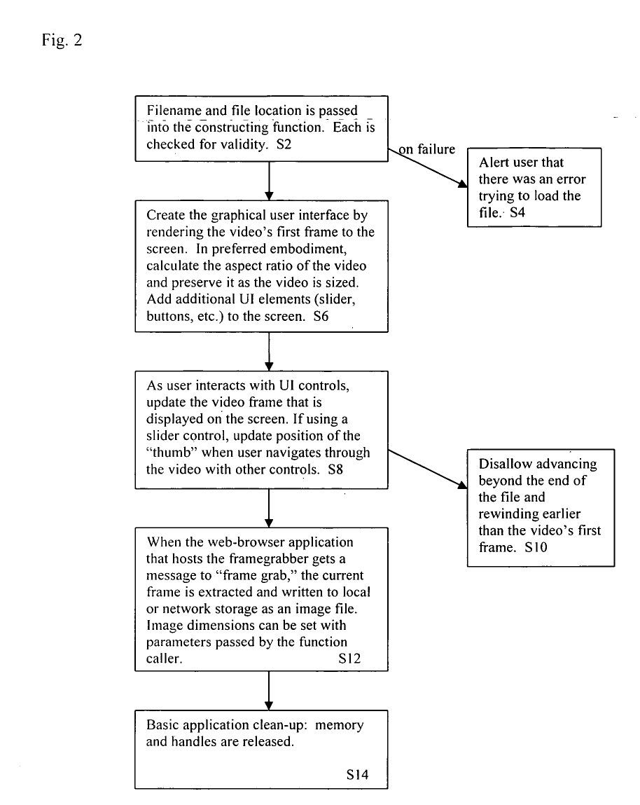

FIG. 2 describes the flow-of-control as it pertains to framegrabbing according to an embodiment of the present disclosure. Though not free-standing like a conventional application, the frame grabber is self-contained and has a consistent behavioral process. For example, according to this embodiment of the present disclosure, the frame grabber is hosted inside a web browser or another application that supports plugins. Video file information such as Filename and file location are passed via an exposed LoadFile function into a constructing function. The frame grabber can then check to see if that file is valid (Step S2). This can be done by using a variety of functions that come with code libraries for managing video. These-libraries are often used in video editing/management software. One example of these libraries would be Microsoft's DirectShow.

If the file is invalid or cannot be loaded, the user can be notified and the process can be aborted or restarted (Step S4). However, if the video file poses no problems, the first. frame of the video can be rendered to the screen (Step S6). Any user interface elements for video navigation can then be drawn to the screen (see FIG. 3A) and the frame grabber can wait for user interaction. If a user navigates through the file using one or more of the user interface elements, the current frame can be rendered to the screen and the current position in the file can be stored in memory (Step S8). In an embodiment of the present disclosure, if a user attempts to advance beyond the last frame or rewind beyond the first frame, he is prevented from doing so (Step S10).

When a user decides on the particular frame to grab, he can instruct the framegrabber, via a user interface element or some other way, to call the plugin's GrabFrame function. According to an embodiment of the present disclosure, the GrabFrame function takes optional parameters that control the dimensions of the resulting image file. The GrabFrame function copies the current frame into memory and subsequently writes that same data to disk in a valid image file format, such as jpeg format (Step S12). Standard application clean-up is then performed and handles and memory are released (Step S14).

FIG. 3 is an overview of a sample user experience when accessing the present system for frame grabbing according to embodiments of the present disclosure. As shown, a user turns on the computer and launches the web browser (Step S30). Upon loading a web page that properly deploys the frame grabber (see preceding paragraphs for deployment procedure), a user can be presented with a choose video file control 302 including a browse button 304 such as that shown in FIG. 3C. In FIG. 3C, this button is attached to a function that allows the user to navigate the hard disk for the desired video file. According to other embodiments, the user can specify the path and filename in the edit box 306 or the developer can provide an altogether different system for file selection. Upon the user selecting the file (Step S32), the web page displays the first frame of the video in a window 308 and displays any user interface elements that allow navigation within the video.

The user can then navigate through the video using one or more user interface controls (Step S34). For example, according to an embodiment of the present disclosure shown in FIG. 3, a slider 314 and frame step buttons 310, 312, 316 and 318 allow the user to easily navigate through the video. Buttons 310 and 318 are fast rewind and fast forward buttons, respectively, allowing the user to rewind or advance 10 frames at a time. Buttons 312 and 316 allow the user to rewind or advance 1 frame at a time. Slider 314 allows the user to drag and click pointer 326 to a new position in the video and indicates the current position in the video. The user can then keep track of the current location in the video by watching the time display 320 or in other embodiments, by watching the display of the current frame number (not shown). Furthermore, the current frame displayed in window 308 is updated each time the user interacts with the navigation controls 310-318. In the embodiment shown, the frame grabber is one step of a larger process, and the “Cancel” and “Next” buttons allow a user to access other portions of the process that may be unrelated to frame-grabbing. Clicking the “Next” button 324 can call the GrabFrame function, resulting in a graphics file being written to the hard disk, while clicking the Cancel button 322 can abort the frame-grabbing process.

### Web-Driven Transcoding

According to embodiments of the present disclosure, a software tool allows a user to transcode an audio or video file via a web-interface. Transcoding applications generally range from medium to high complexity, and require users to have, at the very least, a rudimentary understanding of codecs, codec parameters, and containers. Often times, transcoders are executed using a command-line interface, compelling the user to enter an arcane list of preferences. By moving the process off the command line (or traditional GUI application) and into a web browser, embodiments of the present disclosure can optionally be configured to reveal one or more details of the transcoding process to users. In that regard, transcoding can be almost entirely automated or can involve the user in a more significant way. Key components in this process are two browser plugins and a command-line transcoder. One example of a web browser and plugin system is Internet Explorer and ActiveX. There are a variety of command line transcoding applications; one that is widely used is called mencoder and is part of the mplayer project.

FIG. 1 shows how all of the components involved in transcoding relate to one another hierarchically. The hardware is standard for computers (CPU, RAM, hard disk, video card, etc.) and is abstracted via the operating system and libraries, i.e. the developer need not address the hardware directly. Embodiments of the present disclosure are primarily concerned with the application layer 116 and above. In particular, there are two applications that are important to the process a transcoder application 118 and a web browser application 120. The transcoder application 118 does the actual work of converting the file to the desired format and the web browser application 120 hosts the plugins that make the process seamless and transparent to the user. Transcoders and web browsers are general-purpose standalone applications, and neither will be described in detail in the present disclosure. One browser plugin, the File Information Extractor 124 can query a file for information about its contents, namely codecs that it uses and the container type. Another browser plugin, the System Messaging Tool 126, can send messages from the browser to another application.

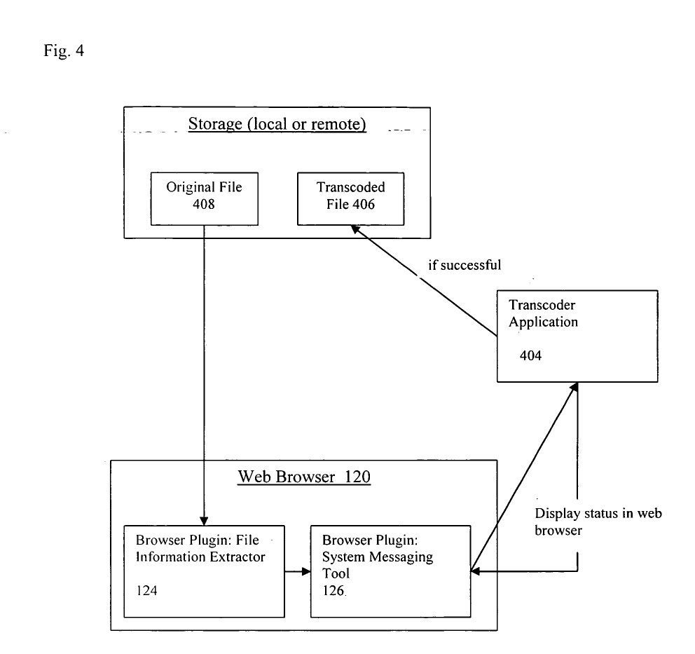

FIG. 4 describes the flow-of-control as it pertains to transcoding according to an embodiment of the present disclosure. Neither the File Information Extractor 124 nor the System Messaging Tool 126 functions as a free-standing application but rather are hosted inside the web browser 120 or another application that supports plugins. After a file 408 is loaded, the File Information Extractor 124 can determine information about the file, such as codec or container type. The type of information that can be extracted is fairly broad. For example, characteristics like frame rate, dimensions, bitrate, and more can be queried. For purposes of ease of description of embodiments of the present disclosure, the focus is on container and codec types. Once this information is known, the system can decide whether a file is acceptable using one or more criteria. For example, the criteria might be that the system is capable of transcoding files with certain codecs and/or containers. A file with codecs and/or a container that doesn't meet those criteria can be transcoded. If the file meets the criteria, that a file be transcoded, and the System Messaging Tool 126 can launch the transcoder 404. In one embodiment of the present disclosure, the criteria can be predefined. In another embodiment, the user can control one or more criteria through the use of a graphical user interface (not shown).

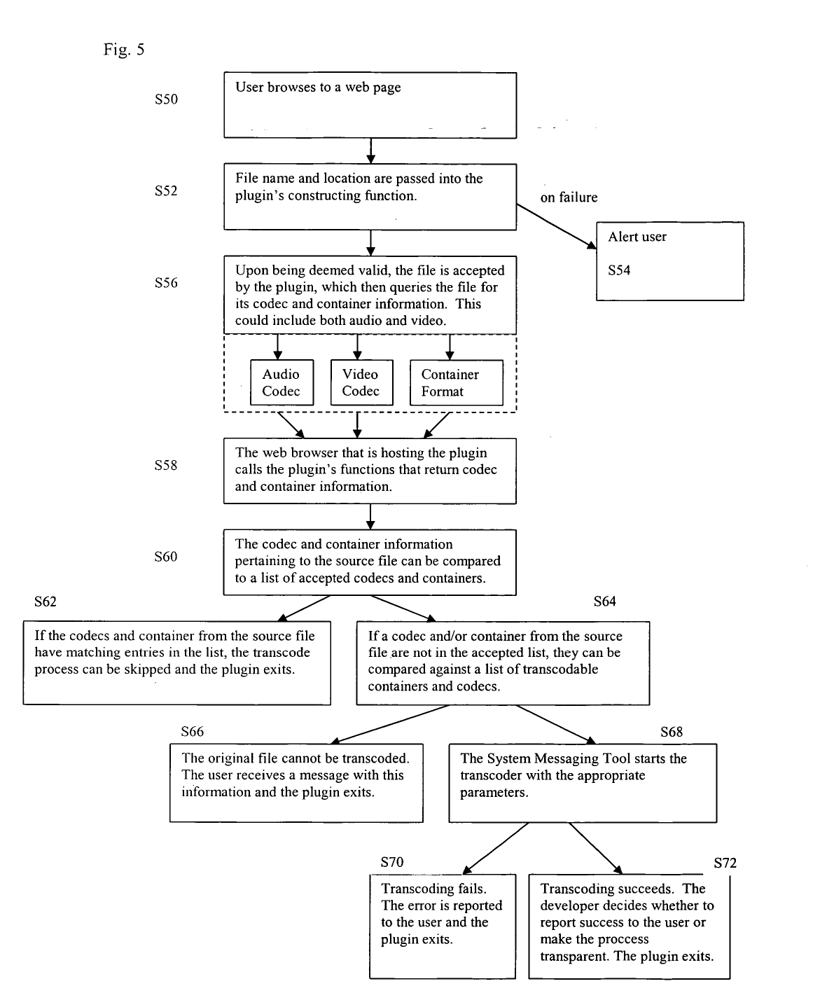

Once the transcoder 404 has been launched, the System Messaging Tool 126 can query for the transcoder status at specific intervals. In one embodiment of the present disclosure, as the System Messaging Tool 126 returns the status of the transcoding operation, the status can be displayed to the user via the web browser 120. In another embodiment of the present disclosure, the status is not displayed during the operation, but at the completion of the operation, when either success or failure is indicated to the user. In yet another embodiment of the present disclosure, the fact that transcoding is occurring is completely transparent to the user, and no status is displayed. If the transcoder succeeds, the transcoded file 406 is written to a storage such as a disk.

Whereas FIG. 4 explains the high-level interaction between the various components of the system, FIG. 5 offers a lower-level explanation of the programmatic flow-of-control as it pertains to transcoding. FIG. 5 shows the flow by the web browser and transcoder components, and focuses in particular on the plugins. The user begins by browsing to a web page that contains the File Information Extractor plugin and attempts to load a media file (Step S50). After a file is loaded via the web browser, the file name and location are passed into the plugin's constructing function and various checks can be performed on the file, such as verifying that the file exists or that it is in a usable format (Step S52). If one of the checks fails, an error message can be displayed to the user and the rest of the process can be skipped (Step S54). The File Information Extractor then examines the file and extracts information about its audio codec, video codec, and container format, storing them in variables (Step S56). The File Information Extractor then exposes functions to the web browser hosting the plugin that allow programmatic access using a browser scripting language like, but not limited to, Javascript. The codec and container information are then returned (Step S58). These functions return the values that are stored in the variables. After this information has been retrieved, the File Information Extractor plugin is no longer needed.

In an embodiment of the present disclosure, after the script is used to acquire information about the codecs and container, that information can be compared to an initial list (Step S60), the “accepted format list.” By programmatically comparing the codecs and container of the initial file against this list, it can be determined whether or not transcoding should proceed. In another embodiment of the present disclosure, transcoding can proceed on any file without comparing its information to a list. In an embodiment of the present disclosure, if the file can be accepted without transcoding, the user can optionally be notified and the transcoding process can be skipped (Step S62). On the other hand, if the file cannot be accepted without transcoding, the file's codecs and containers can be compared against a second list that contains a list of codecs and containers that are accepted by the transcoder (Step S64). If there is no match with the second list, the transcoding process can be aborted (Step S66). If there is a match with the second list, the System Messaging Tool can send a message to the transcoder to begin transcoding (Step S68). One example of a messaging system is DDE on Microsoft Windows.

While transcoding is underway, the System Messaging Tool can optionally query the transcoder application for status about the operation. In an embodiment of the present disclosure, in-progress status can be reported to the user via the web browser, while in another embodiment, the status can be discarded. If the transcoder is unable to complete transcoding, the System Messaging Tool can make that information available to the browser (Step S70). The user can be notified and the System Messaging Tool can exit. If transcoding succeeds, the user can optionally be notified and the process can continue (Step S72). At this point, the transcoding process is complete and the System Messaging Tool can exit.

### Web-Driven P2P Uploads

According to an embodiment of the present disclosure, a process is provided that allows a user to upload a file to a P2P network via a web interface. Prior to the widespread introduction of HTTP upload support in web browsers, users managed uploads with FTP clients. These clients were often complex to use, but offered the user status and progress updates, and in some cases, recoverability. For example, if a file upload was interrupted, the user could restart the upload from the stopping point. In many cases FTP-based uploads have been replaced by HTTP-based uploads. The simplicity of HTTP uploads via a web browser has made this the most common upload experience, but has introduced new limitations. For example, web-browser uploads typically don't give the user indications regarding progress or status. Furthermore, there exists no capability to recover from errors; in the event of a problem, users start their upload process anew.

Embodiments of the present disclosure combine the ease-of-use of a web-based experience with the robustness of a standalone client. This is done through the use of two components: a browser plugin, one type of plugin being an ActiveX control used in conjunction with Internet Explorer, and a P2P-enabled client application.

FIG. 1 shows how all of the components involved in the upload process relate to one another hierarchically. Embodiments of the present disclosure are generally concerned with the application layer and above. There are two applications that are particularly important to the process—a client application 128 and a web browser 120. The client application 128 does the actual work of file uploading and the web browser 120 hosts the System Messaging Tool 126 that makes the process seamless and transparent to the user. The System Messaging Tool 126 is important in that it manages messaging between applications, allowing communication between the web browser and the client application.

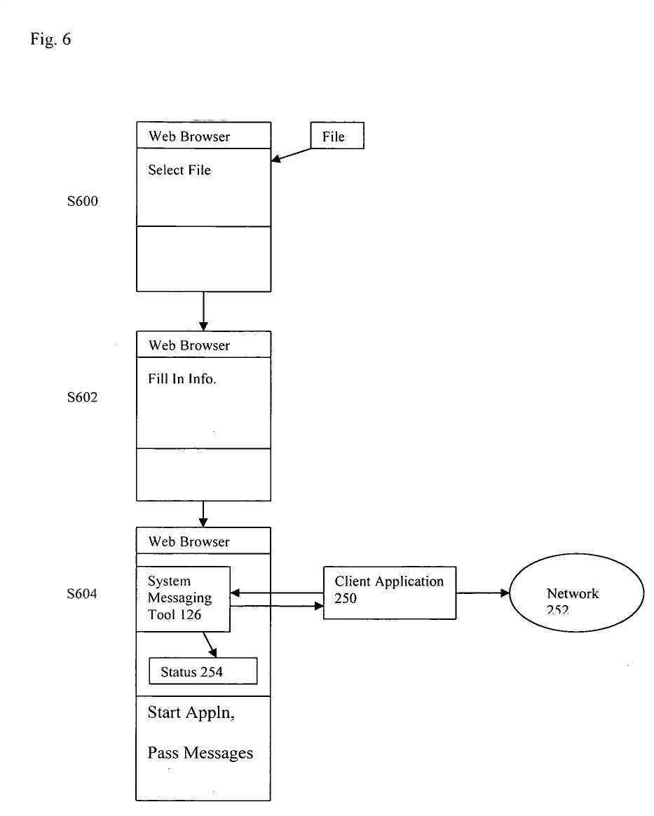

FIG. 6 describes flow-of-control as it pertains to uploading files using a P2P-enabled client application according to embodiments of the present disclosure. The System Messaging Tool does not function as a free-standing application, but rather is hosted inside a web browser or another application that supports plugins. In an embodiment of the present disclosure, before the file upload commences, information about the file or about the upload process is first gathered from the user. This could be a multi-step process in which significant metadata is collected or a simple single-step process where the user just specifies which file should be uploaded. That is, using an interface displayed by the web page, the user selects the particular file to be loaded (Step S600). This can be in the form of a browse button, for example, that allows the user to search a hard disk for a desired file. The user then fills in all of the required information presented in the web page. For example, if the file is a video file, this might include metadata about the length, description, director, etc. of the video. A large document might require the user to enter different information. At the conclusion, the user clicks a button that begins the upload process (Step S602). Steps S600 and S602 could be collapsed into one step, or Step S602 could be eliminated altogether.

After the file is specified and any required fields have been entered, the user can begin the upload using a user interface button. Through the use of a scripting language, such as Javascript, Jscript, or VBScript, clicking the user interface button can cause a function to be called on the System Messaging Tool 126, which can in turn send a message with the full path to the file to the client 250. The client 250 can connect to the P2P network 252 and begin the process of uploading the file. In an embodiment of the present disclosure, this is done by sending a message to a central Admin Server (not shown) notifying it to begin a P2P upload. The System Messaging Tool can query the client or the Admin Server for progress and status at some desired interval. The client 250 passes status messages 254 back to Messaging Tool 126, which then updates the status section of the web page (Step S604). In an embodiment of the present disclosure, the percentage of uploading completed can be displayed to the user via the web browser, along with any error messages. According to an embodiment, the client 250 uploads the file to one or more peers in the network 252. The status (errors, percent complete, and/or “finished”) can be monitored by either the client or another system within the network.

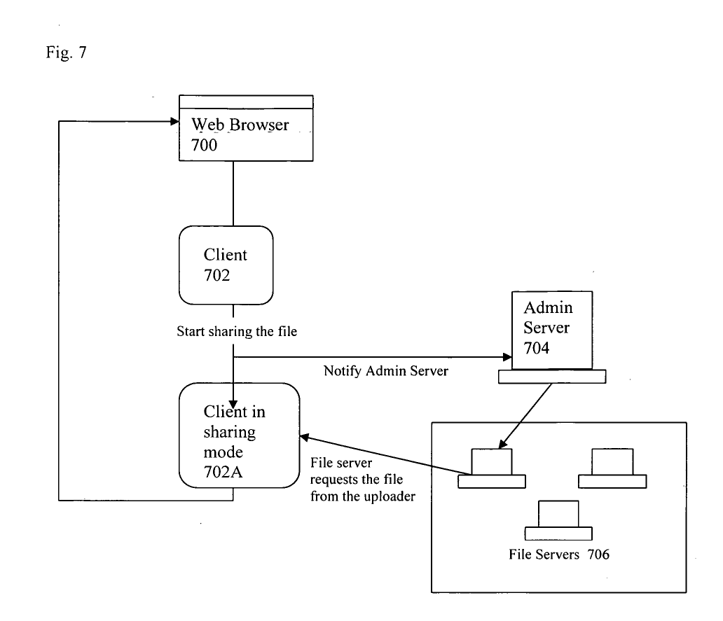

To understand the specific actions that take place, reference is now made to FIG. 7. As indicated earlier, the upload process is started when the client application receives a message from the System Messaging Tool which is running inside browser 700. For example, on a Windows computer running Internet Explorer, the System Messaging Tool might be an ActiveX control that sends and receives DDE messages; on a Unix-based computer running Mozilla Firefox, the System Messaging Tool might be implemented using JavaScript. The System Messaging Tool sends the location (e.g., path) and name of the file to the client 702. Once the client 702 receives this information, it enters a sharing mode to begin sharing the file and notifies a central Administrative Server (Admin Server 704) that it has the file. The Admin Server 704 then selects one or more File Servers 706 to start downloading the file from the uploader (e.g., client 702A). File Servers 706 can be chosen by a variety of methods. For example, according to an embodiment of the present disclosure, file servers are chosen that have the most available system resources, such as storage space or processor cycles. In other embodiments, file servers that are known to be geographically close to the uploader are chosen. When the File Servers have been selected, they are instructed to initiate a P2P download of the file from the uploader 702A.

After receiving the message from the Admin Server 704, the chosen File Servers 706 can begin downloading the file from the user's machine (e.g. client 702A). The progress of the upload operation can be monitored by either the client 702A or by the Admin Server 704, and this information can be relayed back to the web browser 700 using the System Messaging Tool. The user can be consistently apprised of the status and can be informed when the process completes. Unlike a conventional HTTP upload, when using embodiments of the present disclosure, the user does not need to remain on the web page. In fact, he can browse to another page, another site, or even close the browser altogether. Leaving the site or closing the browser will preclude the display of current status, but the upload process can continue uninterrupted.

In the event that the upload process is somehow interrupted, e.g. power failure, loss of network connectivity, etc., the client can choose to resume the upload when it has restarted. According to an embodiment of the-present disclosure, File Servers 706 can continue to attempt to download the file from the client 702A without interruption. In another embodiment, File Servers 706 can stop the download attempt if they determine that the client 702A is no longer available. In this case, when the client 702A resumes the upload, it can send a message via the Admin Server 704 to the File Servers 706, instructing them to continue downloading the file.

### Time-Based User Quotas

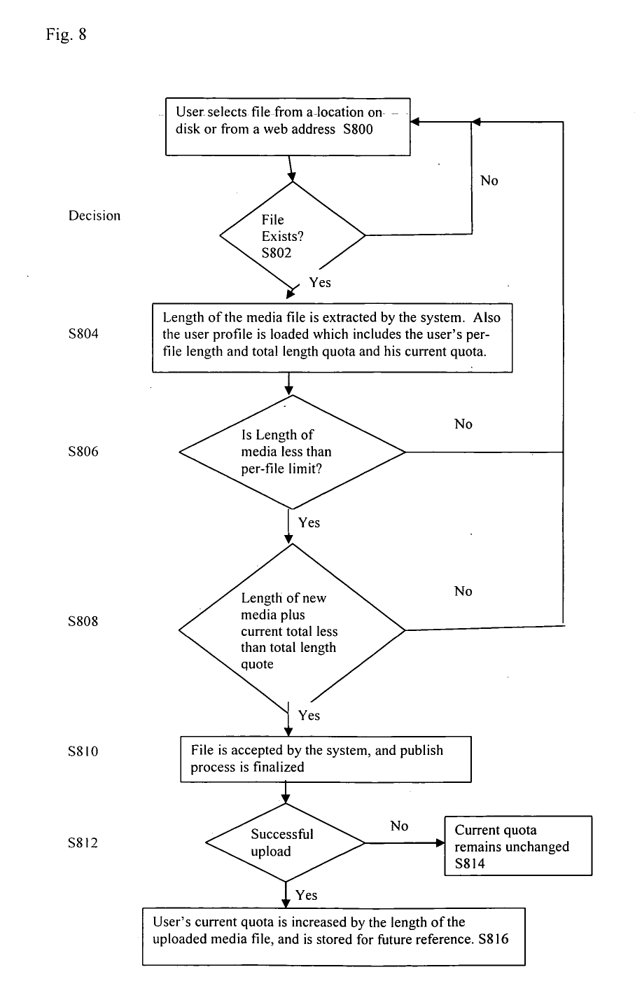

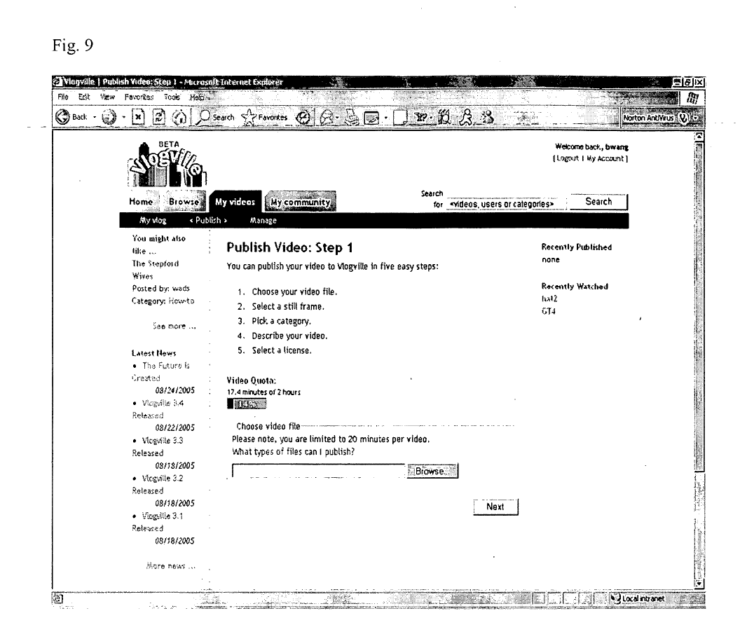

According to an embodiment of the present disclosure, a system is provided which allows for restricting user uploads of media files based on time. The system can be described in detail by reference to the following detailed description of FIG. 8 and is depicted in FIG. 9.

The user starts out by selecting a media file (Step S800). This selection can be done using a web page, a standalone application or another interface. Once the file is selected, the file can be validated (Step S802). At this point, the file can be rejected if it does not exist or otherwise cannot be processed (No, Step S802) and the process can be aborted or restarted with a different file. If the file is valid (Yes, Step S802) the valid file is passed into the time length extraction function (Step S804). The function will load the file and determine its running time. Determining a media file's running time is a common procedure and will not be described in further detail in the present disclosure. Once the running time is determined, the next step is to determine the user's time limitation. This value can be the same for all users or it can be specified on a per-user basis in the user's profile. If a profile is used, the user profile can be loaded based on-a user identifier that is stored in the system. The next step is to load the user's current usage total. This can be calculated by examining each of the user's previous uploads that still resides on the server and adding up the time durations. Additionally, this value can be stored so that it does not have to be frequently re-calculated. At this point, the system may have three numbers associated with the particular user: the per-file time length limitation, the total time length limitation and the current total. The system checks whether the length of the currently selected media file is less than the user's per-file limit (Step S806). If the file's length exceeds the per-file limitation (No, Step S806), the process can be aborted or restarted with a different file. If the media is less than the user's per-file limit (Yes, Step S806), length of the currently selected file is added to the current usage total, and this resulting value can be compared to the total length quota (Step S808). If it exceeds the quota, the process can be aborted or restarted with a different file (No Step S808). If it does not exceed the quota (Yes, Step S808) the process proceeds to complete the upload process (Step S810). When the upload process is complete, it can be considered to have failed or succeeded. If the upload succeeded (Yes, Step S812), then the user's current quota total can be incremented by the length of the newly uploaded file, (Step S816). This total can be used in future quota calculations as noted in the earlier steps. If the load was not successful (No, Step S812), the current quota is not changed (Step S814).

### Content Validation in a Grid-Based CDN

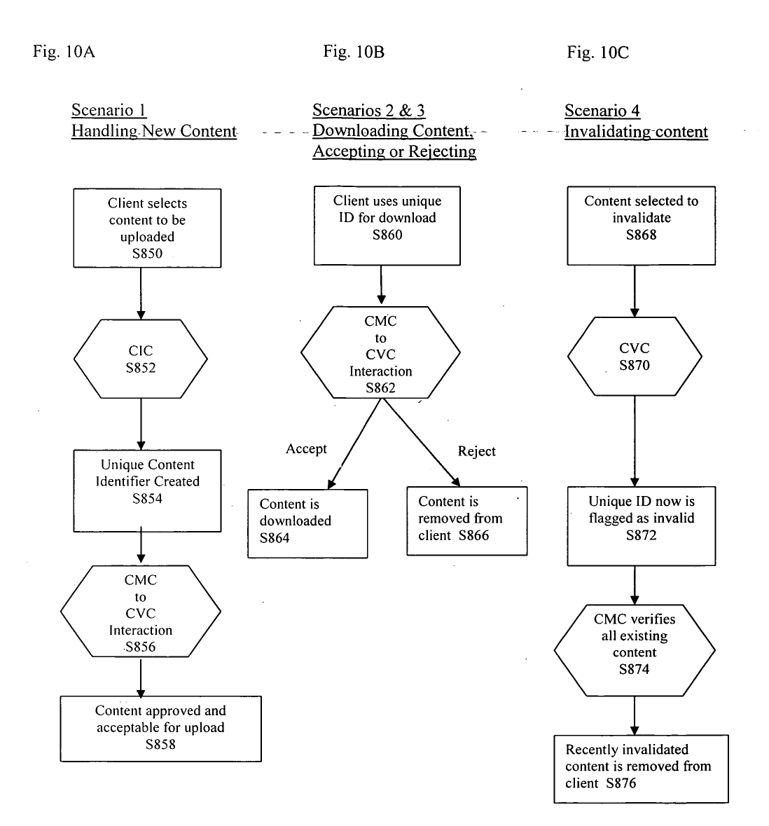

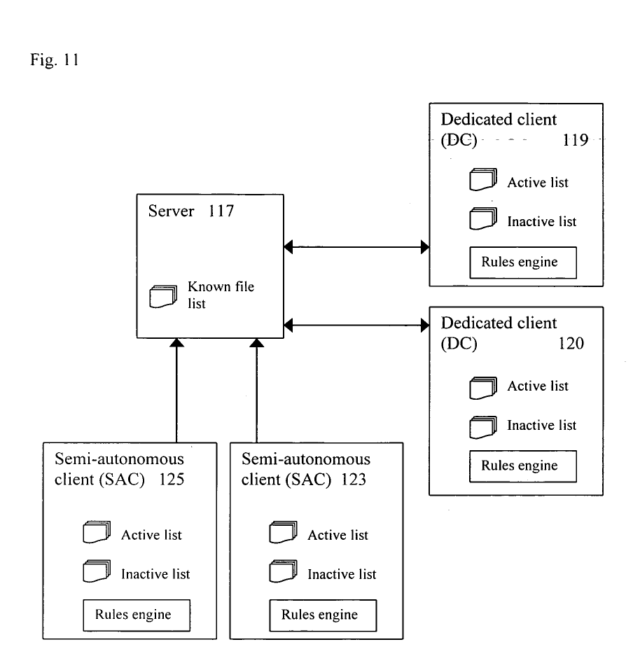

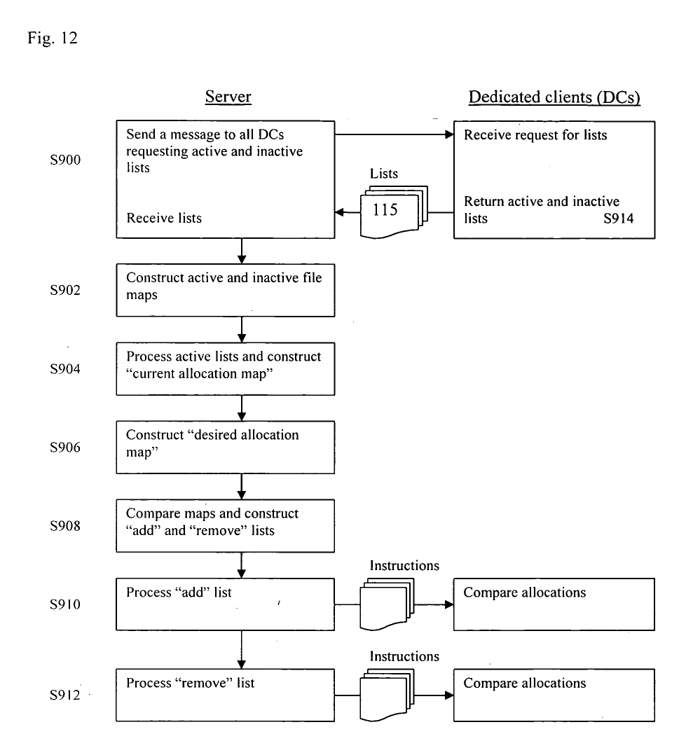

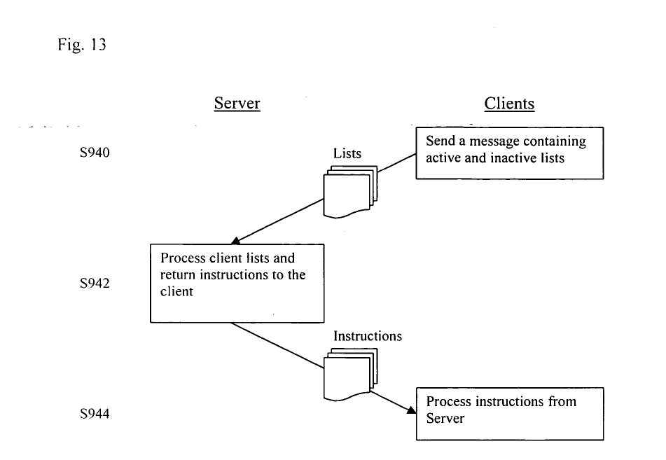

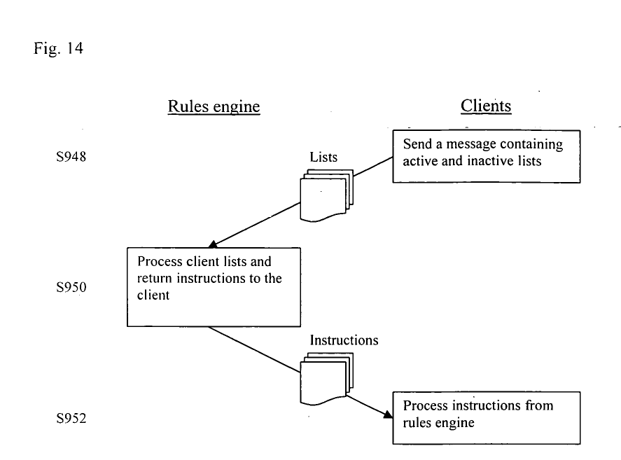

According to an embodiment of the present disclosure, a system is provided for validating content files in a distributed network. Since this portion of the disclosure has 4 different scenarios, as depicted in FIGS. 10A-10C, the discussion of each scenario will be separate and shall be explicitly listed below. The detailed description of each scenario will explain how the disclosure's components are utilized.

Scenario 1: Handling new content. First, a content file is selected for upload (Step S850). The particular selection process used is immaterial to the present disclosure, and thus will not be discussed in detail. The file content is then passed to the disclosure's Content Identification Component (CIC) (Step S852) located on the client's machine. This component will read the bytes within the file, and based on those bytes, create a unique hash for it (Step S854). The hashing algorithm is not particular to this disclosure and different ones may be used. Once there is a unique identifier for the content, the Client Management Component (CMC) also located on the clients machine will communicate with the Content Verification Component (CVC) (Step S856) located on a server. This communication involves sending notification to the CVC that there is a new piece of content available for upload and that future attempts to download this content should be accepted by the CVC (Step S858). Once this process has completed, the client is ready to upload the content to the network, and furthermore, make itself available as a source for the content from other peers in the network (as by design in a P2P network). One example of how the upload could proceed is detailed in the description above.

Scenarios 2 and 3: Downloading accepted or rejected content. This scenario covers the case of a client downloading a new-piece of content or having already downloaded the piece of content and sharing it with network peers (see FIG. 10B). The client uses a unique ID (e.g., hash) identifying the content to be downloaded (Step S860). At some predetermined interval, the client's CMC will communicate with the CVC about each piece of content using the content's hash, regardless of the means by which the client is aware of the content (Step S862). The CVC will look up the content hash with its master list and will either reject or accept the content. Once the CMC receives the answer from the CVC, it will do one of two things. If the CVC rejects the content, the CMC will remove the hash from its download list, stop sharing the content, and remove it from disk (Step S866). If the content is accepted, it can be downloaded (Step S864). In the case where a peer has already downloaded the content, that peer can continue to serve the content. This mechanism can be employed by every client in the network, so at any point, if an authorized user or application disables the content on the CVC, all clients in the peer network will stop serving the file, and any subsequent new downloads can be rejected.

Scenario 4: Invalidating content. In the following scenario, content files can be marked as invalid for any of a number of reasons (see FIG. 10C). Some examples include if the content is identical to another piece of content, if a user requests that the content is deleted from the system, or if an administrator decides for some reason that the content should be deleted from the system. Choosing which files should be invalidated can be implemented in a variety of ways, including but not limited to a web UI, client application or automated system. Once the content is selected (Step S868) and is ready for invalidation, the CVC server checks against its master lists, and marks that the content's unique hash is invalid (Step S870). The unique ID is flagged as invalid (Step S872). At this point, as described in Scenario 2 and 3, the clients CMC will check periodically against the CVC for all content it is hosting or check the CVC when it begins a new download (Step S874). Once the hash has been invalidated, any future requests by the client for the invalid content will be rejected. The invalidated content is then removed from the client (Step S876).

### Controlling Content Availability in a Grid-Based CDN

According to an embodiment of the present disclosure, a system is provided for adjusting the availability of one or more content files in a distributed network. Each file in the network can be considered to have a certain allocation. The allocation can be described by a list of clients on which the file is available. Alternatively, the allocation can be described simply by the total number of clients on which the file is available. In embodiments of the present disclosure, the Server can have control over each file's allocation in the network, by telling clients which files to make available.

The Server can use a variety of strategies for determining how widely spread a file should be. For example, one strategy could dictate that every file should be available on a fixed percentage of the clients in the network, such as 50%. Another strategy could dictate that files that are requested most often (“popular files”) should be available on all clients, while files that are requested least often (“unpopular files”) should be available only on a minimum number of clients, such as 1 or 2. Other files can be made available on a number of machines proportional to how-often-they are requested. When-the network is started, the Server can use a default strategy. The Server can be reconfigured at a later time to use a different strategy.

As shown in FIG. 11, embodiments of the present disclosure make use of one or more servers 117, one or more dedicated clients 119-121 and one or more semi-autonomous clients 123-125.

The following examples describe different ways in which allocation of files across the network can be controlled, according to embodiments of the present disclosure.

### EXAMPLE 1

Centralized control of each DC's file allocation. On a schedule, the Server 117 can adjust the file allocation on all Dedicated Clients (DCs) using the process shown in FIG. 12. A message is first sent by server 117 to each DC 119-121 requesting its lists of active and inactive files. The lists 115 are then stored in temporary storage in server 17.

For each file known to the Server 117, a list is constructed of DCs on which the file is active and a list of DCs on which the file is inactive (Step S902). These are stored in two new mappings, “DCs with active file” and “DCs with inactive file.” These mappings can be used later to decide which DCs should receive which instructions.

Each DC's active list is examined and a new mapping (“current allocation map”) is constructed representing the current allocation for each file (Step S904). According to an embodiment of the present disclosure, the allocation can be in the form of a list of client identifiers on which the file is available. Alternatively, it can be the number of clients on which the file is currently available.

A new mapping (“desired allocation map”) is constructed containing the desired allocation for each file known to the Server 117, according to the Server's current file allocation strategy (Step S906). According to an embodiment, the same allocation is assigned for each file regardless of other criteria. According to another embodiment, the system takes into account attributes of the file's usage within the network, such as how often the file is requested or the last time it was requested. Yet another embodiment takes into account various attributes of the file itself, such as the date on which it was created, the size of the file, or, for video files, the video codec used in the file.

For each file known to the Server 117, the current allocation is compared to the desired allocation using the mappings (Step S908). If a file's current allocation is the same as the desired allocation, no action is required for this file. If a file's current allocation is below the desired allocation, the file is added to an “add list.” This is a list of files whose allocation should be increased, along with the number of clients on which the file should be added. If a file's allocation is above the required allocation, the file is added to a “remove list.” This is a list of files whose allocation should be decreased, along with the number of clients on which the file should be removed.

The add list is processed, consisting of files whose allocation should be increased, in order to determine what instructions to send to which DCs (Step S910). Another list, a list of DCs on which the file is not currently available, can be used in making this determination. This list consists of all the DCs on which the file is absent, plus all the DCs on which the file is present but inactive. DCs can be chosen from this list until the number matches the increase in desired file allocation. The method for choosing DCs can be random, or it can be based on some useful criteria. For example, DCs can be selected that have the most available disk space, thereby choosing a DC whose disk capacity is best suited to accommodate the new file. As another example, DCs can be selected which have done relatively little processing recently, thereby choosing a DC whose processor is best suited to accommodate the new file. As yet another example, a DC might be selected if it already has the file but the file is in its inactive list, thereby eliminating the need to send the file to the DC. After the DCs have been chosen, the Server can send a message to each chosen DC. If the DC already has the file, but the file is inactive, the message can be an instruction to move the file from the DC's inactive list to the active list. If the DC does not yet have the file, the message can include an instruction to download the file from other clients and then add the file to the DC's active list.

The remove list is then processed, consisting of files whose allocation should be decreased, in order to determine what instructions to send to which DCs (Step S912) Another list, a list of DCs on which the file is currently available, can be used in making this determination. DCs can be chosen from this list until the number matches the decrease in desired file allocation. The method for choosing DCs can be similar to the method used for files whose allocation should be increased, for example: random, DCs with the least available disk space, or DCs that have done a lot of processing recently. After the DCs have been chosen, the Server can send a message to each chosen DC. The message can include an instruction to move the file from the DC's active list to the inactive list. Alternatively, the message can include an instruction to remove the file from the active list and delete the file itself.

The semi-autonomous clients (SACs) 123-125 query the administrative server 117 for instructions describing which of the content files should be made available to other clients. The SACs may also use a rule-based engine to decide which content files should be made available to other clients.

### EXAMPLE 2

Clients query for instructions regarding desired availability. In this example, DCs and Semi-Autonomous Clients (SACs) behave in the same fashion, so the term “client” is used.

On a schedule, clients can perform the following steps shown in FIG. 13 to adjust availability of files they already have.

A client sends a message to the Server 117 containing the client's active and inactive lists (Step S940). Upon receiving the message, the Server 117 can process each list and determine if any change in availability is desired. For each file in the active list and inactive lists, the Server can decide to change the file's availability if the file meets certain criteria used by the Server (Step S942). For example, if a file is considered unpopular, sufficiently available, or insufficiently recent, the file may be designated for moving from the active to the inactive list. As another example, if a file's status within the Server 117 has changed from “valid” to “invalid,” the file may be designated for deletion. Similarly, if a file is considered popular, insufficiently available, or sufficiently recent, the file may be designated for moving from the inactive to the active list. The Server can return a set of instructions to the client indicating what action, if any, should be taken on each file.

After receiving the list of instructions from the Server, the client can process each instruction (Step S944). One instruction might be to move a file from the client's active list to the inactive list. Another instruction might be to move a file from the inactive list to the active list. Yet another type of instruction might be to delete a file from either list and also delete the actual file from disk.

### EXAMPLE 3

Clients use rules to determine desired availability. In this example, DCs and SACs behave in the same fashion, so the term “client” is used.

On a schedule, clients can perform the following steps shown in FIG. 14 to adjust availability of files they already have.

For each file in the client's active and inactive lists, a client queries a rules engine for instructions on what steps, if any, should be taken with the file. The rules engine can be a module contained within the client, or can reside on a different computer (Step S948)

The rules engine can process the client lists to determine, for each file, if any action is required. The engine can make this decision using attributes of the rules engine itself as well as attributes of the file. The engine might decide that a certain maximum number of files can be active at any given time, and that all other files should be placed in the inactive list. The engine can use various criteria to decide each file's priority for placement in the active or inactive lists. For example, the engine might decide that files which the client has had for the longest duration, or which the client has been making active for the longest duration, or which were initiated into the network by the client, or which were retrieved from other clients in the network, deserve special consideration for the purposes of prioritizing the list. Once the rules engine has decided the appropriate changes to the active-and inactive lists, a set of instructions can be returned to the client (Step S950).

After receiving the list of instructions from the rules engine, the client can process each instruction (Step S952). One instruction might be to move a file from the client's active list to the inactive list. Another instruction might be to move a file from the inactive list to the active list. Yet another type of instruction might be to delete a file from either list and also delete the actual file from disk.

Accordingly, it will be appreciated that the present disclosure describes a system allowing users to share files in a content delivery network (CDN). Some of the salient features are summarized below.

Web-based video frame grabber. A feature found in many video editing applications is the ability to extract a single frame of video from a video file or stream. This feature is sometimes referred to as “frame grabbing.” The present disclosure describes a frame grabber that has been integrated into the web browser. The web-based frame grabber can then be combined with a larger web-based process, such as uploading video from one computer to another, for a seamless web experience.

Web-driven transcoding. The present disclosure details a process by which a user can determine a video file's format, and subsequently convert the file to another video format if necessary, through the use of a web browser. By performing this process in a web browser, it can be incorporated into a larger process of uploading a file from one computer to another over a distributed network. Furthermore, performing the often time-consuming process of transcoding on a user's computer can eliminate the need for one or more server machines that might otherwise be required.

Web-driven peer-to-peer upload. The present disclosure details a process and software for allowing end users to upload files via a web page, using a peer-to-peer (P2P) client application that runs in the background. The user interacts with the web browser, which in turn, interacts with the client. When the client receives a message to upload a file, rather than using a traditional method of upload such as FTP or HTTP, it uses P2P technology to transfer the contents of the file to other peers in the network. When one or more peers have received the complete file, the upload process can be considered complete.

Time-based quota for user media uploads. According to aspects of the present disclosure, a user's upload limitation is based on the running time, or length, of a set of media files. Each file that is uploaded can be compared to a maximum allowed length. Additionally, the total length of all files uploaded by a user can be compared to a cumulative maximum length. Whenever a user uploads a new media file, the length of the file is determined, and a decision can be made to accept or reject the file based on the file's length, the user's maximum allowed length, and the cumulative maximum length.

Content validation in a distributed network. The present disclosure describes a method for accepting or rejecting content in a distributed network environment. In traditional distributed networks, managing the content on the individual nodes can be complicated or near impossible. By design, many P2P and distributed networks do not have the ability to accept and reject content due their decentralized designs. Even in distributed networks that have a central server, the server often lacks management capability and is unable to validate content. The present disclosure addresses how to validate content in a distributed network.

Controlling propagation and availability in a distributed network. A content delivery network (CDN) can be used to distribute files over the Internet. Whereas a conventional client-server system employs a many-to-one relationship, CDNs typically use a many-to-many relationship, thereby leveraging the processing power and bandwidth of all of the computers in the network. In order for the CDN to be effective, files should be adequately propagated across the network. However, excessive propagation of a rarely-used file is wasteful of system resources. The disclosure describes a method to control propagation of content so that its availability is appropriate at all times.

Embodiments, of the present disclosure provide salient advantages. For example, the present disclosure is advantageous in that it provides an interface for frame grabbing that can range from simple to complex. In one embodiment of the present disclosure, potentially confusing aspects of a frame grabber are eliminated, allowing the user to grab a frame with simplicity. This approach can reduce user confusion and the errors that result from it. In another embodiment, the developer who is implementing the web-based frame grabber can configure additional features (one example might be the ability to capture multiple frames), allowing for a richer and more powerful user experience.

Another advantage of aspects of the present disclosure is that, since it functions inside a web browser, it can be integrated into a website. People who use frame grabber applications are frequently responsible for uploading the resulting image file to a web site, and/or creating a web page to display the image, so that it can be viewed on a network such as the Internet. The disclosure allows for the frame grabbing process to be integrated into a web-based publishing process, offering end users even greater simplicity.

With the growing presence of video on the Internet, it's increasingly important to make sure that the audio or video is in a widely audible or viewable format. Although transcoding is a technically complex process, the present disclosure provides a way to shield the end user from details of that process. By connecting a web browser to a transcoder, the user can achieve the desired result of converting the format while still enjoying a familiar web experience.

According to aspects of the present disclosure, the parameters of the transcoding process can optionally be presented to the user. In one embodiment of the disclosure, users may not be aware that any conversion of the file has occurred, which may be desirable for novice users. In another embodiment of the disclosure, a variety of transcoding options can be presented to the user, which may be desirable for expert users. Because the transcoding process can be controlled by a web page, it can be integrated into a website and, in one embodiment of the disclosure, made a component of a larger file publishing process. The optional publish process is not covered by this disclosure.

The value of incorporating transcoding into the publish process—and doing so on the end user's computer—is significant. First, by examining the media files and classifying them as acceptable, transcodable, or rejected, it can be assured that files are in a certain format and, therefore, that the files can be shared with a wide audience. Second, transcoding is extremely computationally expensive. By converting files in a distributed fashion, additional servers, which might otherwise be needed for transcoding files, can be reduced in number.

As storage and bandwidth availability increase, personal computer users are transferring increasingly large files among themselves. When this is done via a web interface, the process typically involves using a generic HTTP upload interface. The inherent limitations in HTTP and in web browsers can result in an unsatisfactory user experience.

The present disclosure addresses some of the significant shortcomings inherent in web-based uploading. The present disclosure refers to a browser and a P2P-enabled client application. By shifting the actual uploading from the browser to the client, while preserving the familiar web interface, functionality is enhanced and the user experience is improved. A P2P upload allows for greater fault-tolerance than a traditional FTP or HTTP upload.

There are several components to the time-based quota system. First, a component extracts the running time of the media file, whereas a conventional quota system component would extract the file's size in bytes. Second, the user's account profile is loaded to inspect the user's per-file and total length limitation. Third, the user's current time-based quota is retrieved. Finally, when a user uploads a file, the user's per-file limit and total quota can be checked to see if the file should be accepted or rejected.

The time-based system described in the present disclosure has several benefits compared to a size-based system. First, while creative users who produce media files are usually interested in the duration of their files as it is relevant to their listening or viewing audience, they may be less concerned with the amount of disk space consumed by the files. Second, the amount of disk space required for a given media file can vary drastically depending on the format or quality level that is used. According to an embodiment of the present disclosure, a user does not have to sacrifice quality to satisfy a file size limitation. Third, both users and system administrators have a convenient method for viewing system usage-in a way that makes sense to non-technical users. The system can calculate total playing time available for user download, thereby providing users with a more relevant metric on the amount of available media content.

As noted earlier, the disclosure combines qualities of two types of networks: a traditional centrally managed content network and an open peer-to-peer network. The first advantage is the security aspect of the present disclosure. Despite the embodiment's P2P attributes, it, is still able to track content in the network, disabling and removing files that have been tagged invalid. This disabling applies to all clients in the network, and thus can be seen as a P2P delete or disallow mechanism. The second advantage of the present disclosure is that it can keep track of disallowed content and prevent future uploads of such content. Finally, the present disclosure allows management of a distributed, highly fragmented P2P network. A P2P network can be inherently unwieldy due to its design, but the present disclosure assists in maintaining order in a typically chaotic technology. In short, the present disclosure allows for a highly efficient P2P-type network without giving up security, validation and content management capabilities that are usually associated with closed, managed networks.

As in a traditional CDN, the present disclosure distributes files among clients participating in the network. However, unlike traditional CDNs, in the present disclosure the allocation of content across the network is dynamic and can be controlled from a central server or by a set of predefined rules. By controlling the allocation of content, service levels can be guaranteed and disk savings can be achieved.

The present disclosure has three main systems. The administrative server (“Server”) can coordinate actions of the clients using one of two methods: sending instructions to them, or receiving requests from them for instructions. The Server maintains a list of all files that are known to be in the network. Dedicated clients (“DCs”) receive instructions from a Server regarding what content to propagate and make available to other clients. DCs can also make decisions based on a set of rules, using various criteria of a file such as the file's date, size, name, or location. Each DC maintains a list of files that it has and that are available to the rest of the network (“active list”), and a list of files that it has but are not available to the rest of the network (“inactive list”). Each DC has a unique identifier—known to the Server—which the Server can use to communicate with the DC. Finally, semi-autonomous clients (“SACs”) query a Server for instructions about what content to make available. As with DCs, SACs can make decisions based on a set of rules. Also, as with DCs, SACs maintain an active list and an inactive list. The disclosure offers several benefits compared to a typical CDN. First, a given file's availability can be guaranteed to meet a predetermined minimum number of computers in the network, thereby achieving a minimum level of service. Second, a given file's availability can be guaranteed to not exceed some predetermined maximum number of computers in the network, thereby achieving disk savings. Finally, the allocation of a file can be changed in a dynamic fashion, with or without human intervention, so that the allocation is always appropriate.

What is claimed is:

1. A method for processing video comprising:
providing a framegrabbing plugin that extracts still frames from a video stream and is integrated into an application that hosts plugins; and
providing a user interface allowing a user to select still frames to extract from the video.

2. The method according to claim 1, wherein the application that hosts plugins comprises a web browser.

3. The method according to claim 2, wherein the web browser comprises at least one of Internet Explorer, Safari and Firefox.

4. The method according to claim 1, wherein said framegrabbing plugin is packaged as a reusable library consisting of compiled code.

5. A method for converting a media file comprising:
a file information extractor plugin that extracts information from a file and is integrated into an application that hosts plugins; and
a transcoder for converting a media file as a result of a user's interaction with the application that hosts plugins.

6. The method according to claim 5, wherein the application that hosts pilgrims comprises a web browser.

7. The method according to claim 6, further comprising a system messaging tool integrated into the web browser for providing communication between the file information extractor plugin and the transcoder.

8. The method according to claim 5, wherein the media includes at least one of audio and video.

9. The method according to claim 5, further comprising providing a list of information including accepted codes and containers.

10. The method according to claim 9, further comprising extracting information from the file and comparing the extracted information to the list of information.

11. The method according to claim 10, further comprising a list of transcodable containers and codecs.

12. The method according to claim 11, further comprising comparing the extracted information to the list of transcodable containers and codecs.

13. The method according to claim 12, wherein if the information is not on the list of transcodable containers and codecs, information is sent indicating that the file cannot be transferred.

14. The method according to claim 5, wherein the converting of the media file occurs on a same machine as the application that hosts plugins.

15. A software plugin comprising:
code for extracting information from a file; and
code for comparing the extracted information to at least one list to determine whether transcoding of the file is at least one of required and possible.

16. A method for validating content comprising:
determining whether content should be accessible to peers on a P2P network;
allowing a user to mark his own content uploaded to a P2P network as invalid.

17. The method according to claim 16, further comprising removing content marked as invalid from the user's machine.

18. A distributed computer network comprising:
a central administrative server;
at least one client including at least one content file, wherein the central administrative server sends said at least one client instructions describing which of the at least one content files should be made-available to other clients.

19. The distributed computer network according to claim 18, wherein the client comprises at least one of a dedicated client and a semi-autonomous client.

20. The distributed computer network according to claim 19, wherein said at least one semi-autonomous client queries said central administrative server for instructions describing which of the at least one content files should be made available to other clients.

21. The distributed computer network according to claim 19, wherein said at least one semi-autonomous client uses a rule-based engine to decide which of the at least one content files should be made available to other clients.

22. The distributed computer network according to claim 18, wherein a number of copies of content files on each client is derived from at least one of a client's geographic location, a file's timestamp and a client's network participation.

23. The distributed computer network according to claim 22, wherein the client's network participation is defined by a number of bytes uploaded or downloaded by the client.

24. The distributed computer network according to claim 22 wherein the client's network participation is defined by a number of files served by the client.

25. A computer recording medium including computer executable code for processing video comprising:
code for providing a framegrabbing plugin that extracts still frames from a video stream and is integrated into an application that hosts plugins; and
code for providing a user interface allowing a user to select still frames to extract from the video.

26. A computer recording medium including computer executable code for converting a media file comprising:
file information extractor plugin code that extracts information from a file and is integrated into an application that hosts plugins; and
transcoder code for converting a media file as a result of a user's interaction with the application that hosts plugins.

27. A computer recording medium including computer executable code for validating content comprising:
code for determining whether content-should be accessible to peers on a P2P network; and
code for allowing a user to mark his own content uploaded to a P2P network as invalid.
